(19) United States
(12) Patent Application Publication
(10) Pub. No.: US 2014/0193987 A1
(43) Pub. Date: Jul. 10, 2014

(54) ELECTRICAL CONTACT DEVICE

(71) Applicant: Simo Kaurala, Somero (FI)

(72) Inventor: Simo Kaurala, Somero (FI)

(73) Assignee: SALCOMP OYJ, Salo (FI)

(21) Appl. No.: 14/128,196

(22) PCT Filed: Jul. 26, 2012
(86) PCT No.: PCT/FI2012/050754

§ 371 Date: Dec. 20, 2013

(30) Foreign Application Priority Data
Jul. 29, 2011 (FI) 20115775

(51) Int. Cl. H01R 12/57

(52) U.S. Cl. CPC H01R 12/57
USPC 439/81; 439/786

(57) ABSTRACT

The present invention relates to an electrical contact device which comprises an electrically conductive base part, and an electrically conductive protruding part protruding from the electrically conductive base part. The electrical contact device also comprises an electrically conductive coil spring having a diameter that increases from a first end to a second end of the electrically conductive coil spring. The electrically conductive coil spring is arranged around the electrically conductive protruding part in such a manner that the first end of the electrically conductive coil spring faces the electrically conductive base part, and the electrically conductive coil spring extends further from the electrically conductive base part than the electrically conductive protruding part does.

### TECHNICAL FIELD OF THE INVENTION

The present invention relates to an electrical contact device according to the preamble of the appended independent claim. The invention also relates to an electrical contact arrangement incorporating an electrical contact device according to the invention.

### BACKGROUND OF THE INVENTION

An electrical device typically comprises a plurality of electrical contacts between electrical components and/or parts of the device. Electrical contacts may be implemented using various types of contact devices. For example, electrical components may be connected via solder joints to a printed circuit board (PCB), and the circuit board may be connected via its contact pads to contact pins, which deliver electrical current to the circuit board.

An example of an electrical contact device according to the prior art for conducting electrical current to a printed circuit board is illustrated schematically as a cross section in FIG. 1. The electrical contact device 10 comprises at its first end a V-shaped part 11, which has been arranged in contact with a contact pad 12 of the printed circuit board 13. The V-shaped part 11 is bendable in a longitudinal direction of the electrical contact device 10 so that the V-shaped part 11 may bend towards the second end of the electrical contact device 10 when it is pressed against the contact pad 12. The restoring force of the bent V-shaped part 11 keeps the electrical contact device 10 in contact with the contact pad 12 so that the V-shaped part 11 does not have to be separately attached to the contact pad 12 via such means as a solder joint or the like. Electrical current is fed to the electrical contact device 10 through a conductor 14, which has been coupled to the second end of the electrical contact device 10. Another end of the conductor 14 has been connected to a plug pin 15. The electrical contact device 10, the circuit board 13 and the conductor 14 are arranged inside a housing 16. The plug pin 15 is arranged to go through a wall of the housing 16.

A problem associated with the electrical contact device of FIG. 1 and other known contact devices relates to safety distances that are required from electrical components on a printed circuit board. Especially a problem relates to safety distances that are required from primary side components around leads before a fuse resistor. Because of the size and shape of known electrical contact devices, a large safety (component free) area on the circuit board around a contact pad is needed in order to ensure safe use of the electrical device. This limits the minimum achievable size of the printed circuit board and thereby the size of the electrical device, which is a problem especially in small-sized electrical devices, such as a battery charger of a mobile phone.

Another problem is that electrical contact devices of the prior art are expensive and laborious to manufacture, mainly because of their shaped parts.

### OBJECTIVES OF THE INVENTION

It is the main objective of the present invention to reduce or even eliminate prior art problems presented above.

It is an objective of the present invention to provide an electrical contact device enabling to conduct electrical current via a contact pad to a printed circuit board. In more detail, it is an objective of the invention to provide a small-sized electrical contact device, which enables to use a smaller safety (component free) area on a printed circuit board around a contact pad compared to what is achievable with electrical contact devices of the prior art.

It is also an objective of the invention to provide an electrical contact device, which is easy and inexpensive to manufacture. It is a further objective of the invention to provide an electrical contact device, which is easy to assemble.

It is also an objective of the present invention to provide an electrical contact arrangement enabling to conduct electrical current to a printed circuit board of an electrical device.

In order to realise the above-mentioned objectives, the device according to the invention is characterised by what is presented in the characterising part of the appended independent claim. Advantageous embodiments of the invention are described in the dependent claims.

### DESCRIPTION OF THE INVENTION

A typical electrical contact device according to the invention comprises an electrically conductive base part, and an electrically conductive protruding part protruding from the electrically conductive base part. The typical electrical contact device according to the invention further comprises an electrically conductive coil spring having a diameter that increases from a first end to a second end of the electrically conductive coil spring, the electrically conductive coil spring being arranged around the electrically conductive protruding part in such a manner that the first end of the electrically conductive coil spring faces the electrically conductive base part, and the electrically conductive coil spring extends further from the electrically conductive base part than the electrically conductive protruding part does.

The base part and the protruding part may be elements of a one-piece part, or they may be separate parts which have been attached together. A first end of the protruding part is in contact with the base part. A second end of the protruding part is opposite to the first end of the protruding part. The protruding part can be essentially elongated. The protruding part may have a form of a cylinder.

The base part and the protruding part form a contact pin to which the coil spring has been attached. A first end of the coil spring is arranged in contact with the protruding part and/or the base part whereby electrical current may flow through the electrical contact device, i.e. from the base part to the coil spring.

The coil spring is formed into the shape of a helix which returns to its natural length when unloaded. The coil spring can be stretched and compressed in its longitudinal direction. The coil spring is a compression spring which is designed to become shorter when loaded. Preferably, turns of the coil spring (excluding the end turns) are not touching in an unloaded position.

In a protruding direction of the protruding part, the coil spring extends further from the base part than the protruding part does. By a protruding direction of the protruding part is meant a direction from the first end of the protruding part to the second end of the protruding part.

That the coil spring extends further than the protruding part from the base part refers to a situation where the coil spring is in a rest position, i.e. in an unloaded position. When the coil spring is compressed the coil spring becomes shorter and a situation may occur where the coil spring extends as far as the protruding part from the base part, or not even that far.

The diameter of the coil spring increases from the first end to the second end of the coil spring. In other words, the coil spring is a volute spring, i.e. a compression spring in the form of a cone. Preferably the coil spring is designed so that under compression the coils are not forced against each other.

The base part, the protruding part and the coil spring are manufactured from electrically conductive material. Suitable materials are for example steel, brass, copper, tin bronze, stainless steel and beryllium copper.

The electrical contact device according to the invention is suitable for conducting electrical current to a printed circuit board. The electrical contact device can be arranged in contact with a contact pad of the printed circuit board. Because the coil spring in a rest position extends further from the base part than the protruding part, the electrical contact device can be arranged in contact with the contact pad in such a manner that only the coil spring is connected to the contact pad. The restoring force of the compressed coil spring keeps the electrical contact device in contact with the contact pad. The coil spring does not have to be separately attached to the contact pad via such means as a solder joint or the like. Because the coil spring can compress and stretch in its longitudinal direction, an electrical connection between the electrical contact device and the contact pad may be maintained even in a case where the printed circuit board slightly moves relative to the electrical contact device.

An advantage of the invention is that it enables to use a very small printed circuit board area for the safety (component free) area around the contact pad. Because the electrical contact device according to the invention does not comprise V-shaped, U-shaped or the like parts, it is the size of the contact pad which mainly defines the area on the printed circuit board to which area it is not safe to connect electrical components.

Safety distance depends on voltage. For example, for a voltage of 250 V, the standard IEC 60950 requires a 2.5 mm safety distance from an AC voltage lead to primary side components of a switched-mode power supply before a fuse resistor.

This means that the distance from the electrical contact device, the contact pad and the leads, to the primary side components before the fuse resistor must be at least 2.5 mm. With the present invention if the size of a contact pad is, for example, 3 mm×3 mm, then the size of the safety area is 5.5 mm×5.5 mm, on the centre of which area the contact pad is located. In summary, when using the electrical contact device according to the invention, electrical components can be arranged closer to the contact pad, in contrast to when using electrical contact devices of the prior art.

An advantage of having an increasing diameter from the first end to the second end of the coil spring is that a certain compression travel can be achieved with a shorter coil spring. Another advantage is that the coil spring may only grip the protruding part from its first end and therefore the coil spring maintains its flexibility.

An advantage of the invention is that a robust electrical connection can be obtained with the present invention.

Still another advantage of the invention is that the electrical contact device is easy to manufacture.

According to an embodiment of the invention the first end of the electrically conductive coil spring is arranged against the electrically conductive base part. This arrangement prevents the first end of the coil spring from moving in the longitudinal direction of the protruding part when the coil spring is compressed. The coil spring has been arranged around the protruding part by pushing or pulling the coil spring along the protruding part until the first end of the coil spring comes into contact with the base part. By arranging the first end of the coil spring against the base part, the coil spring need not be separately attached to the protruding part.

According to an embodiment of the invention the electrically conductive protruding part has an essentially round cross section. Because the turns of the coil spring are essentially round, the coil spring can be arranged around the protruding part in such a manner that the transverse movement of the coil spring is minimised. The protruding part may alternatively have other shapes, such as a rectangular cross section.

According to an embodiment of the invention the minimum inner diameter of the electrically conductive coil spring is smaller than the diameter of the electrically conductive protruding part. The minimum inner diameter of the coil spring can be, for example, less than 0.5 mm smaller than the diameter of the protruding part. Preferably the minimum inner diameter of the coil spring is less than 0.3 mm and more preferably less than 0.15 mm smaller than the diameter of the protruding part.

That the minimum inner diameter of the coil spring is smaller than the diameter of the protruding part refers to a situation where the coil spring has not yet been arranged around the protruding part. When the coil spring is attached to the protruding part the coil spring stretches in a transversal direction. Also the abovementioned numerical values refer to a situation where the coil spring is in an unloaded situation.

An advantage of having the minimum inner diameter of the coil spring smaller than the diameter of the protruding part is that the coil spring fits tightly around the protruding part, without using any separate attaching means. Another advantage is that this makes it easier to assemble an electrical contact device and a printed circuit board together because the coil spring stays around the protruding part in any orientation.

According to an embodiment of the invention the electrically conductive coil spring extends at least 0.1 mm further from the electrically conductive base part than the electrically conductive protruding part does. This means that the coil spring can be compressed by at least 0.1 mm in the longitudinal direction of the protruding part before the second end of the coil spring comes to the same level with the second end of the protruding part. Thus, the electrical contact device when connected to a contact pad allows a movement of at least 0.1 mm without disconnecting an electrical connection. Preferably the coil spring extends 0.1-5 mm and more preferably 0.5-1.3 mm further from the base part than the protruding part.

The above-mentioned numerical values refer to a situation where the coil spring is in a rest position. When the electrical contact device is arranged in contact with a contact pad, the coil spring is compressed and thus the second end of the coil spring is closer to the second end of the protruding part than in the rest position.

According to an embodiment of the invention the number of turns of the electrically conductive coil spring is at least 3. Preferably the number of turns of the coil spring is 3-10 and more preferably 3-5.

According to an embodiment of the invention the electrically conductive base part comprises a groove arranged around the circumference of said electrically conductive base part in a plane perpendicular to the protruding direction of the electrically conductive protruding part. The groove enables an easy way to attach the electrical contact device, for example, to a housing of a battery charger. The electrical contact device, which has a groove in its base part, can be used as an insert in an injection moulding process, and therefore the electrical contact device can be attached to the housing at the same time when the housing is injection moulded.

According to an embodiment of the invention the electrically conductive base part is a plug pin. In other words, the electrical contact device may be integrated into the plug pin. The plug pin can be, for example, an AC pin of a battery charger to an end of which the protruding part has been arranged in such a manner that the protruding direction of the protruding part corresponds to the longitudinal direction of the AC pin. In a case where the base part and the plug pin are separate parts the base part may be connected to the plug pin through a conductor.

According to an embodiment of the invention the length of the electrically conductive coil spring is at least 0.5 mm. Preferably the length of the coil spring is 0.5-5 mm and more preferably 2-3 mm.

According to an embodiment of the invention the electrically conductive coil spring is at least 0.1 mm longer than the protruding part. Preferably the coil spring is 0.1-5 mm and more preferably 0.5-1.3 mm longer than the protruding part.

According to an embodiment of the invention the inner diameter of the electrically conductive coil spring is 1-4 mm. Preferably the inner diameter of the coil spring is 1-3 mm and more preferably 1.5-2 mm.

According to an embodiment of the invention the length of the electrically conductive protruding part is at least 0.5 mm. Preferably the length of the protruding part is 0.5-5 mm and more preferably 0.8-2 mm.

The invention also relates to an electrical contact arrangement, which comprises a printed circuit board having a contact pad. The electrical contact arrangement comprises an electrical contact device according to the invention, the electrically conductive coil spring of the electrical contact device being arranged in contact with the contact pad. The number of the contact pads on the printed circuit board may vary depending on the application. Each of the contact pads may be coupled with an electrical contact device according to the invention. The contact pad is made of electrically conductive material, such as tin.

According to an embodiment of the invention the contact pad defines an aperture arranged to receive an end of the electrically conductive protruding part. Because the end of the protruding part may penetrate into the aperture, the total height of the combination of the electrical contact device and the contact pad can be very low. The aperture is preferably round and arranged on the centre of the contact pad.

According to an embodiment of the invention the contact pad comprises protrusions on the surface of the contact pad, the second end of the electrically conductive coil spring being arranged in contact with the protrusions. The contact pad may comprise two, three, four or even more protrusions. Preferably, the protrusions are arranged as a circle on the surface of the contact pad. The diameter of the circle preferably corresponds to the diameter of the second end of the coil spring.

According to an embodiment of the invention the size of the contact pad is less than 5 mm×5 mm. Preferably the size of the contact pad is less than 4 mm×4 mm and more preferably less than 3 mm×3 mm.

The exemplary embodiments of the invention presented in this text are not interpreted to pose limitations to the applicability of the appended claims. The verb “to comprise” is used in this text as an open limitation that does not exclude the existence of also unrecited features. The features recited in the dependent claims are mutually freely combinable unless otherwise explicitly stated.

### BRIEF DESCRIPTION OF THE DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates an electrical contact device according to the prior art,

FIG. 2 illustrates an electrical contact device according to a first embodiment of the invention,

FIG. 3 illustrates an electrical contact device according to a second embodiment of the invention,

FIG. 4 illustrates an electrical contact arrangement according to an embodiment the invention,

FIG. 5 illustrates a contact pad according to a first embodiment of the invention, and

FIG. 6 illustrates a contact pad according to a second embodiment of the invention.

### DETAILED DESCRIPTION OF THE PREFERRED EMBODIMENTS OF THE INVENTION

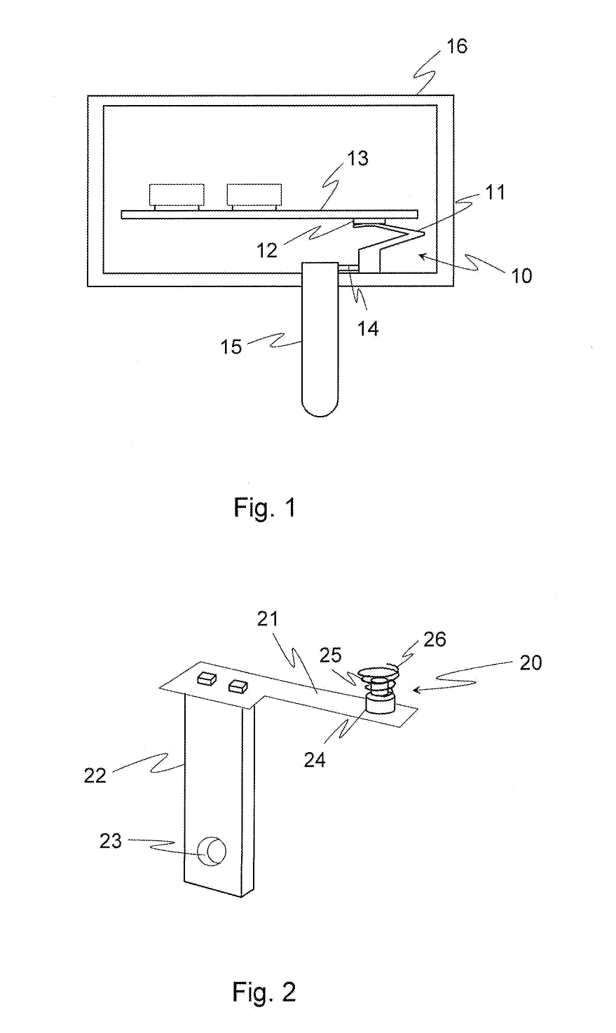

FIG. 1 has been described in detail in the description of prior art. Therefore, the following discussion will focus on FIGS. 2 to 6.

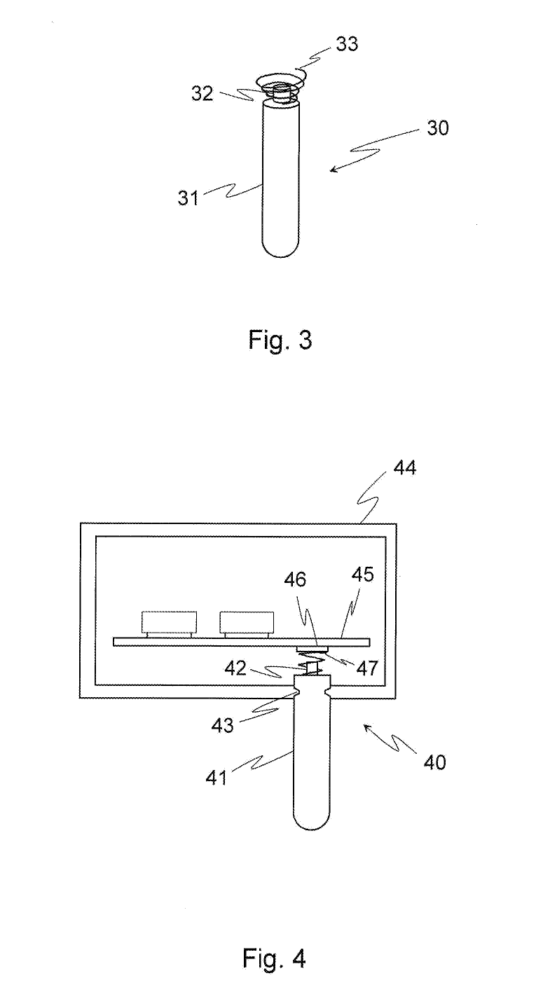

FIGS. 2 and 3 illustrate electrical contact devices according to a first and a second embodiment of the invention. Referring first to FIG. 2, there is shown an electrical contact device 20 which is connected through a conductor 21 to a plug pin 22. The plug pin 22 is a flat-prong type with a hole 23 near the tip, which type is used in, among others, North and Central America, and Japan. In some countries, such as China, the plug pin does not have to have a hole near the tip.

The electrical contact device 20 of FIG. 2 comprises an electrically conductive base part 24 and an electrically conductive protruding part 25 which protrudes from the base part 24. The base part 24 and the protruding part 25 are elements of a one-piece part. A first end of the protruding part 25 is in contact with the base part 24 and a second end of the protruding part 25 is opposite to the first end of the protruding part 25. The protruding part 25 has a form of a cylinder.

The electrical contact device 20 of FIG. 2 also comprises an electrically conductive coil spring 26 which is arranged around the protruding part 25. A first end of the coil spring 26 is arranged against the base part 24. A second end of the coil spring 26 is further away from the base part 24 than the second end of the protruding part 25. In other words, in a protruding direction of the protruding part 25 the coil spring 26 extends further from the base part 24 than the protruding part 25 does.

The diameter of the coil spring 26 increases from the first end to the second end of the coil spring 26. In other words, the coil spring 26 is a compression spring in the form of a cone. Before attaching the coil spring 26 around the protruding part 25 the inner diameter of the first end of the coil spring 26 was smaller than the diameter of the protruding part 25. When the coil spring 26 was arranged around the protruding part 25 the coil spring 26 was stretched in a transversal direction so that the inner diameter of the first end corresponds to the diameter of the protruding part 25, whereupon the first end of the coil spring 26 is tightly attached to the protruding part 25.

Referring now to FIG. 3, there is shown an electrical contact device 30 which is integrated into a plug pin 31. The plug pin 31 is a round-prong type which is widely used, for example, in Europe. The round-prong type is also used in India, Korea and Brazil.

The electrical contact device 30 of FIG. 3 comprises the plug pin 31 as an electrically conductive base part to an end of which an electrically conductive protruding part 32 is arranged in such a manner that a protruding direction of the protruding part 32 corresponds to the longitudinal direction of the plug pin 31. An electrically conductive coil spring 33 is arranged around the protruding part 32 in such a manner that in the protruding direction of the protruding part 32 the coil spring 33 extends further from the plug pin 31 than the protruding part 32 does.

FIG. 4 illustrates as a cross section an electrical contact arrangement according to an embodiment of the invention. The arrangement comprises an electrical contact device 40 similar to FIG. 3, except that the plug pin 41 which acts as an electrically conductive base part for the electrically conductive protruding part 42 comprises a groove 43 around the circumference of the plug pin 41. The groove 43 is arranged around the circumference of the plug pin 41 in a plane perpendicular to the protruding direction of the protruding part 42. With the help of the groove 43 the plug pin 41 is attached to a housing 44.

The arrangement of FIG. 4 comprises a printed circuit board 45 inside the housing 44. The electrical contact device 40 is arranged in contact with a contact pad 46 of the printed circuit board 45 in such a manner that only the electrically conductive coil spring 47 is connected to the contact pad 46. The restoring force of the compressed coil spring 47 keeps the electrical contact device 40 in contact with the contact pad 46.

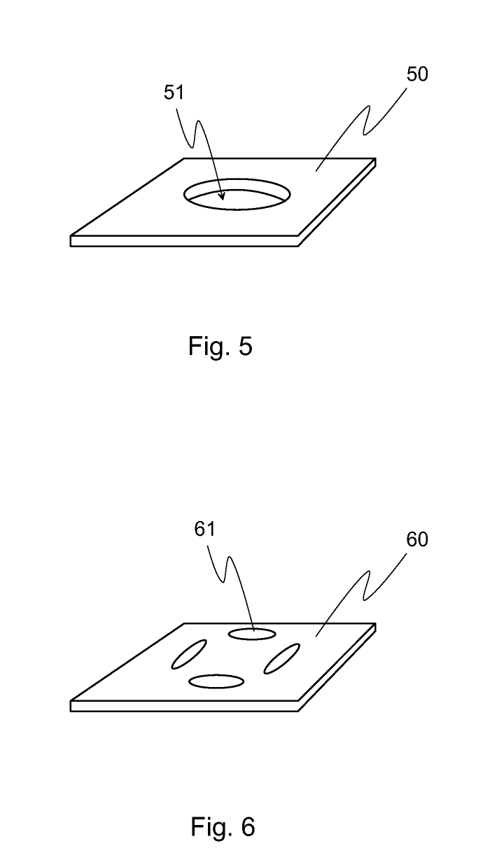

FIGS. 5 and 6 illustrate exemplary structures for a contact pad of a printed circuit board. The contact pad 50 in FIG. 5 defines a round aperture 51. When the contact pad 50 is arranged on a printed circuit board, the surface of the circuit board forms the bottom for the aperture 51. The printed circuit board may not have a through hole which would coincide with the aperture 51. The aperture 51 may receive an end of an electrically conductive protruding part. A second end of an electrically conductive coil spring is arranged to be in contact with the surface of the contact pad 50. The contact pad 60 in FIG. 6 comprises four protrusions 61. The protrusions 61 are arranged as a circle on the surface of the contact pad 60. The circle has a diameter which corresponds to a diameter of a second end of an electrically conductive coil spring. The second end of the coil spring is arranged to be in contact with the protrusions 61.

Only advantageous exemplary embodiments of the invention are described in the figures. It is clear to a person skilled in the art that the invention is not restricted only to the examples presented above, but the invention may vary within the limits of the claims presented hereafter. Some possible embodiments of the invention are described in the dependent claims, and they are not to be considered to restrict the scope of protection of the invention as such.

1. An electrical contact device, comprising:
an electrically conductive base part, and
an electrically conductive protruding part protruding from the electrically conductive base part;
wherein the electrical contact device comprises an electrically conductive coil spring having a diameter that increases from a first end to a second end of the electrically conductive coil spring, the electrically conductive coil spring being arranged around the electrically conductive protruding part in such a manner that the first end of the electrically conductive coil spring faces the electrically conductive base part, and the electrically conductive coil spring extends further from the electrically conductive base part than the electrically conductive protruding part does.

2. The electrical contact device according to claim 1, wherein the first end of the electrically conductive coil spring is arranged against the electrically conductive base part.

3. The electrical contact device according to claim 1, wherein the electrically conductive protruding part has an essentially round cross section.

4. The electrical contact device according to claim 1, wherein the minimum inner diameter of the electrically conductive coil spring is smaller than the diameter of the electrically conductive protruding part.

5. The electrical contact device according to claim 1, wherein the electrically conductive coil spring extends at least 0.1 mm further from the electrically conductive base part than the electrically conductive protruding part does.

6. The electrical contact device according to claim 1, wherein the number of turns of the electrically conductive coil spring is at least 3.

7. The electrical contact device according to claim 1, wherein the electrically conductive base part comprises a groove arranged around the circumference of said electrically conductive base part in a plane perpendicular to the protruding direction of the electrically conductive protruding part.

8. The electrical contact device according to claim 1, wherein the electrically conductive base part is a plug pin.

9. The electrical contact device according to claim 1, wherein the inner diameter of the electrically conductive coil spring is 1-4 mm.

10. An electrical contact arrangement, comprising:
a printed circuit board having a contact pad;
wherein the electrical contact arrangement comprises an electrical contact device according to claim 1, the electrically conductive coil spring being arranged in contact with the contact pad.

11. The electrical contact arrangement according to claim 10, wherein the contact pad defines an aperture arranged to receive an end of the electrically conductive protruding part.

12. The electrical contact arrangement according to claim 10, wherein the contact pad comprises protrusions on the surface of the contact pad, the second end of the electrically conductive coil spring being arranged in contact with the protrusions.

13. The electrical contact arrangement according to claim 10, wherein the size of the contact pad is less than 5 mm×5 mm.
